(19) United States
(12) Patent Application Publication
(10) Pub. No.: US 2026/0292411 A1
(43) Pub. Date: Sep. 24, 2026

(54) Method to mitigate the effect of spatial artifacts in an acoustic signal of a binaural hearing system

(71) Applicant: SONOVA AG, Staefa (CH)

(72) Inventors: Stefan Raufer, Stäfa (CH); Philipp Kohlhauer, Uerikon (CH); Elias Sprengel, Berlin (DE); Henning Hasemann, Berlin (DE); Sebastian Stenzel, Stäfa (CH); Volker Kühnel, Männedorf (CH); Paul Meyer-Rachner, Berlin (DE); Mark Berry, Berlin (DE)

(21) Appl. No.: 19/556,491

(22) Filed: Mar. 4, 2026

(30) Foreign Application Priority Data
Mar. 24, 2025 (EP) 25165714.4

(51) Int. Cl. H04R 25/00

(52) U.S. Cl. CPC H04R 25/453

(57) ABSTRACT

A method to mitigate the effect of spatial artifacts in an acoustic signal in a binaural hearing system is disclosed, with the steps of providing a first hearing device and a second hearing device, comprising a first neural network and a second neural network, each. The neural networks create a first intermediate network data based on the first audio input and a second intermediate network data based on the second audio input, each. A copy of that intermediate network data is sent to the contralateral hearing device, where the neural network units create a first processing instruction and a second processing instruction, respectively, based on the local intermediate network data and the copy of the intermediate network data received. That processing instruction is then applied in each hearing device to process the audio input, each.

### RELATED APPLICATIONS

The present application claims priority to EP Patent Application No. 25165714.4, filed Mar. 24, 2025, which is hereby incorporated by reference in its entirety.

### BACKGROUND

Hearing devices are nowadays dimensionally small and complex devices. Hearing devices can include a microphone, a processor, memory, and other electronical and mechanical components to form an audio signal processor plus a speaker/receiver to emit a sound towards the eardrum, eventually. Types of such hearing devices are Behind-The-Ear (BTE), Receiver-In-Canal (RIC), In-The-Ear (ITE), Completely-In-Canal (CIC), Invisible-In-The-Canal (IIC) devices and in-ear phones. The selection of the type of hearing devices that suits an end user de-pends on factors like the hearing loss, aesthetic preferences, lifestyle needs, and budget. The term “end user” denotes the user of the hearing device.

The hearing device further comprises a battery for providing electrical power to the hearing device and its components including the neural networks and the communication within the hearing system. The battery can be a rechargeable battery or a non-rechargeable battery.

The hearing device may have a vent, i.e., a channel extending between the inside of the ear canal and the outside and the ambient environment (i.e. the region of the pinna) and allows, amongst other effects, for a pressure equalization between those regions when the hearing device is worn. Vents are well-known means to lower undesired acoustic effects like occlusion and sound artifacts and contribute to a better-balanced microclimate with respect to humidity. Although an acoustically closed coupling is preferable in some use situations, an acoustically open coupling can be desired in other use situations (better own-voice perception, environmental awareness). A vent renders a closed coupling towards an open coupling, dependent on the vent size.

Hearing systems and devices with audio signal processing are well known in the art. Audio signal processing may comprise noise reduction routines for reducing or even removing, undesired sound like background sound that is not relevant to the end user, which sound is commonly referred to as acoustic noise or background noise.

Once the noise is removed from an audio input signal, the clarity of a target audio signal contained in the audio input signal is improved substantially. That signal processing is referred to as speech enhancement. Unfortunately, noise reduction, often also referred to as noise cancellation, denoising or noise suppression and its routines are prone to errors and leaving audible artifacts in the output signal depending on signal properties of the audio input signal and on the noise reduction algorithm used. At poor signal-to-noise ratios (SNR) of the audio input signal, noise reduction routines may corrupt and suppress the noise but also the target audio signal and thereby counteracting to the overall purpose of a better understandability of spoken content.

Classic noise reduction schemes in hearing devices make use of so-called classifiers. The classifier analyzes sound scenes based on the audio input arriving at the hearing device and passes a sound classifier information to the system steering of the hearing device. The system steering of the hearing device then decides on what to do with the sound classifier and how to process the audio input signal. The system steering may decide to activate the neural network in some situations or to deactivate it in some other situations. Exemplary sound scenes are “streaming” for listening to music or television, “party mode” for places where many people gather and there is a plurality of simultaneous talking, “restaurant” for a situation where there are not only voices of several people but also sounds of clinking glasses, cutlery and a rather high background noise.

In any sound scene, there is implied information about the venue, i.e. the type of space the listener is in or is connected to and the room's acoustic properties. That implied information is referred to as spatial information or spatial acoustic information.

Tremendous progress in noise reduction was made in recent years in the field of hearing devices by the advent of neural networks in hearing devices. With such a machine learning algorithm that is the result of an intensive training of the neural network, a complicated rule-based algorithm can be replaced. What also became evident was that the technical limits of the sound conditioning is reached by now, such that other methods of improving the sound quality are required that are able to convey the spatial acoustic information to the end user to the eardrum or cochlear implant of the end user. The neural network is a truly self-learning device that can mimic a human brain, and process input. A neural network comprises multiple non-linear computational units or neurons organized in a layer-wise fashion to extract high-level, deeper, robust, and discriminative features from the underlying data. Different network architectures are available, such as a U-net with several layers and nodes.

Hearing devices are often employed in conjunction with communication devices, such as smartphones or tablets, for instance when listening to sound data processed by the communication device and/or during a phone conversation operated by the communication device. More recently, communication devices have been integrated with hearing devices such that the hearing devices at least partially comprise the functionality of those communication devices. A hearing system may comprise, for instance, a hearing device and a communication device. The communication between hearing devices and auxiliary devices such as tablets, smart phones and many more is common nowadays. Hearing devices can execute several wireless communication protocols. For example, hearing devices can use Bluetooth Basic Rate/Enhanced Data Rate™ (Bluetooth BR/EDR™), Bluetooth Low Energy™, a proprietary protocol (e.g., Roger™), or other protocols (e.g., a television streaming protocol). A hearing device may also use Bluetooth BR/EDR™ for streaming music or streaming a phone call. Further, a hearing device may use a proprietary protocol to communicate with another hearing device, e.g., to communicate binaurally or bimodally. For example, a first hearing device can transmit audio to a second hearing device during a wind noise canceling operation.

### BRIEF DESCRIPTION OF THE DRAWINGS

Reference will now be made in detail to embodiments, examples of which are illustrated in the accompanying drawings. The drawings illustrate various embodiments and are a part of the specification. The illustrated embodiments are merely examples and do not limit the scope of the disclosure. Throughout the drawings, identical or similar reference numbers designate identical or similar elements. In the drawings:

FIG. 1 schematically illustrates the core idea of a binaural hearing system;

FIG. 2 schematically illustrates the sequence of various stages of the sound processing of an acoustic audio input in a hearing device;

FIG. 3 schematically illustrates the organization of the sound processing in a binaural hearing system where both neural networks receive the intermediate network data from the contralateral hearing device; and

FIG. 4 schematically illustrates the organization of the sound processing in a binaural hearing system where only one neural network receives the intermediate network data from the contralateral hearing device.

### DETAILED DESCRIPTION OF THE DRAWINGS

The disclosure relates to a method to mitigate the effect of spatial artifacts in an acoustic signal in a binaural hearing system, which method comprises a neural network provided in each hearing device. The disclosure further relates to a training method for training these neuronal networks.

Present noise reduction algorithms in hearing devices are monaural algorithms that work in the left hearing device and the right hearing device independent from one another. It was observed that this led to undesirable, but perceivable spatial artifacts in the acoustic signal leaving the sound processing unit of the hearing device.

It is a feature of the present disclosure to provide an effective method to mitigate the effect of spatial artifacts in an acoustic signal in a binaural hearing system.

A spatial artifact is an undesired acoustic information contained in an acoustic signal that causes a distorted sound perception at the end user and/or disturbs the localization and separation of sound sources.

In very simplified terms, the problem is solved by linking the interference masks of two neural networks on two conventionally monoaurally operated hearing devices such that a binaural hearing system is created. The mask is a complex ratio mask that changes in every frame. The term “mask” functionally corresponds to the term “processing instruction” used in this disclosure. More detailed information is provided below.

In the context of this application, the term binaural hearing system shall also encompass mixed systems with a cochlear implant on one ear and a RIC-type hearing device on the other ear of an end user, for example.

The binaural hearing allows a quality of the “spaciousness” or “high fidelity” to sounds, which is scarce or even absent in monaural hearing systems. Understanding speech clearly, particularly in challenging and noisy situations like a party or a restaurant, for example, is easier when having support from both ears as it leads to a better hearing experience for the end user.

The binaural hearing system described herein overcomes the prior art problem with its limits of the conventional sound conditioning with monoaural hearing devices in that the two hearing devices collaborate with one another.

The end user can benefit from the embodiments described herein also in case that the binaural hearing system is just working partly. Such a partial functionality is formed when one hearing devices does not receive the intermediate network data from the neural network of the contralateral hearing device. Such a situation may occur if one hearing device cannot transmit the intermediate network data to the contralateral hearing device, for example because a power level of the hearing device that is supposed to transmit the intermediate network data is below a predefined safety threshold or because the binaural link or the sending unit is defect. Consequently, the end user profited from an improvement and less effects of spatial artifacts in the acoustic signal only at that ear to which the hearing device is attached that receives the intermediate network data from the contralateral hearing device while the hearing device at the opposite ear cannot contribute to mitigate the effect of spatial artifacts in the acoustic signal received by that hearing device to the same degree since it is not receiving the intermediate network data from the contralateral hearing device. The term transmit does not imply that the intermediate network data is received in the contralateral hearing device.

Below, such a basic embodiment is explained, where only one of the two hearing devices is using the intermediate network data from the contralateral hearing devices to produce the processing instruction locally. In such a scenario, the contralateral hearing device with the second neural network does not receive the intermediate network data from the first neural network and thus produces the second processing instruction locally based on the locally available second intermediate network data only. By the way, neural network runs on a neural network unit. Depending on the embodiment, the neural network unit shall be understood as a functional unit that can extend to more than one computer chip and can encompass other components, too. This shall be permissible as long as it is clear that the neural network is a functionality of the neural network unit in an operating state of the hearing device. An example of a suitable microchip for the neural network unit is disclosed in EP4435668A1.

In a basic embodiment, the method to mitigate the effect of spatial artifacts in an acoustic signal in a binaural hearing system does not need to be perfect to already lead to a perceivable benefit for the end user. Hence, such an imperfect method is hereinafter referred to as a partial binaural hearing system solution.
An illustrative method comprises the following steps:
a) Providing a first hearing device and a second hearing device that are configured for a left ear and a right ear of an end user, respectively, and
wherein the hearing devices are configured to form a binaural hearing system, and wherein the first hearing device comprises a first neural network and the second hearing device comprises a second neural network,
b) Receiving a first acoustic audio input at the first hearing device and a second acoustic audio input at the second hearing device and converting the first acoustic audio input into a first audio input, and converting the second acoustic audio input into a second audio input,
c) Generating first intermediate network data based on the first audio input in the first neural network, and generating second intermediate network data based on the second audio input in the second neural network such that the first intermediate network data comprise at least one first binaural cue, and such that the second intermediate network data comprise at least one second binaural cue,
d) Transmitting a copy of the second intermediate network data from the second hearing device to the first hearing device, while maintaining the second intermediate network data in the second hearing device,
e) Providing in the first neural network a first processing instruction based on the first intermediate network data and the copy of the second intermediate network data received from the second hearing device, and
providing in the second neural network a second processing instruction based on the second intermediate network data,
f) Conducting a signal processing by applying the first processing instruction to the first audio input at the first hearing device, and
the second processing instruction to the second audio input at the second hearing device.

Humans can estimate the location of a sound by analyzing the sounds at their two ears. This is known as binaural hearing and the human auditory system can estimate directions of sound using the way sound diffracts around and reflects from our bodies and interacts with our pinna. As briefly mentioned above, spatial acoustic information is implied acoustic information that indicate the end user some acoustic properties of the room/space in which the end user or the speaker is. The room properties influence the sound perception a lot. That is shown below by way of the following of the two extreme types of such acoustic properties:
a) Open field environment:
   That can be out in mother nature.
   There is an absence of reverberant sounds.
   Having the “acoustic space” information contained in the intermediate network data received from the opposite ear helps the end user perceiving a more authentic sound feeling in that ear.
   The intermediate network data received from the opposite ear helps the end user identifying the sound source and the localization of the sound source better compared to a pair of known, monoaural hearing devices.
b) Closed room
   For example, a small room with little sound absorbing surfaces, such as a tiled bathroom with no/few soft, sound absorbing surfaces. A voice of a speaker in such a room contains a high number of reflections and reverberation caused by the hard surfaces of the room that redirects the speaker's voice.
   For example, a large bedroom with a lot of soft, sound absorbing surfaces like a carpet, curtains, cushions, bedding. A voice of a speaker in such a room contains a lower number of reflections and reverberation because the soft surfaces do not redirect but absorb the speaker's voice.

Spatial acoustic information is a vital part of a binaural sound quality/sound fidelity as it provides the end user with a better hearing perception of the audio inputs since the level difference of the target speaker is optimized compared to conventional monoaural hearing devices. To name an example, the output of the hearing devices has a higher binaural sound quality than hearing devices than conventional hearing devices because the audio input is perceived by the end user as less distorted by the noise reduction than with monoaural systems because the spatial audio information remains preserved in the intermediate network data that is transmitted from each hearing device to the opposite hearing device.

The term “optimized” shall be understood such that it comprises a minimal power usage, a maximum binaural noise suppression, or minimal binaural artefacts, where the performance could be captured using for example a binaural coherence mask or other metrics, or any combination of such metrics.

The neural network is placed on a neural network unit. The neural network is typically unable to learn anything on its own once it is trained and built into the hearing device as it is not designed and trained for such self-learning. Hence, the training of the neural networks is vital to the performance of the hearing system. The training of the neural networks involves a definition about what data from what layers and/or nodes of the neural shall be exchanged as well as how often it shall be exchanged. The latter relates to the so-called cost function of the neural network that will be disclosed in more detail later. However, please note that even the most basic embodiment of the method is not delimited to any neural networks that are not capable of learning anything by themselves. The process of adding additional lessons learned (new capabilities) to the neural networks in the hearing devices can be done by way of a firmware update, during a re-fitting or otherwise.

The neural network is pre-trained with the lessons learned by a fully trained neural network. That is done in that the algorithm with the lessons learned of the fully trained neural network are copied to the neural network units such that the targeted effect is available in an operating state of the hearing system right away. This ensures that the end user can profit from an almost optimal hearing impairment compensation including a spatial artifact mitigation right away once she/he receives a pair of such hearing devices that are capable of operation according to the present method.

The transmitting of the intermediate network data of one hearing device to the contralateral hearing device and vice versa is done by way of streaming. Note that the term “transmit” involves a sending of the intermediate network data but does not strictly imply that the intermediate network data is received by the contralateral hearing device. The streaming is a data transport via a wireless communication like Bluetooth Classic or Bluetooth LE or a proprietary format. The data format can be raw data, or network data in the form of meta-data. In other words, the first/second intermediate network data is network data.

The data contained in the neural network is referred to a meta-data. Meta-data is non-interpretable network data that does not allow a reverse engineering of the audio input received by the first and second hearing device, respectively. It further does not allow the reconstruction of only a part of the audio input. Compared to audio data, meta-data has the advantage that the amount of data to be shared to derive the desired effect is smaller. Even if one compresses the audio data before sending it to the other hearing device, the audio data was still bigger than the meta-data information that comprises the same essential acoustic information data that is shared with the contralateral hearing device.

Examples of meta-data content: The location of a target speaker could be transmitted as meta-information. The “symmetry” of a sound scene could be transmitted as meta-information representing a symmetry score. A target speaker from the front in a diffuse sound scene will have to a high symmetry score. The noise cancelling could be more aggressive. A target speaker from the side with non-diffuse interfering noise will have a low symmetry score. The mixing ratio of the noise cancelling unit is adaptable.

In an embodiment, meta-data can contain data of an initial number of layers of a neural network. Tests revealed that the information at the nodes is already different from the neural network in the first hearing device to the neural network in the second hearing device after the second layer.

Based on the meta-data of the enhancement network, the type of binaural synchronization of the inference masks or audio streams is decided.

Eventually, the signal output of the neural network in the first hearing device and the neural network in the second hearing device can be transformed back into acoustic sound by a receiver (for a classic hearing device) or further used and/or tailored for a cochlear implant application.

Binaural cues provide information on the location of a sound along a horizontal axis by relying on differences in patterns of vibration of the eardrum between the two ears of an end user. Such binaural cues can comprise any noise reduction information but are not restricted to such.

The term “providing the first processing instruction or the second processing instruction” in step e) of the basic embodiment of the method depicted above is to be understood as follows: The first/second neural networks are connected to one another with the goal of maintaining the binaural cues/the fidelity to improve the binaural quality. The binaural fidelity comprises the interaural level difference (ILD), the interaural time difference (ITD), and subjective spatial impression (cannot be measured), a diffusiveness or correlation between the first acoustic audio input at the first hearing device and a second acoustic audio input at the second hearing device and the like. Since the neural networks operate collaboratively and consider network information of the contralateral hearing device, the spatial aspects of the sound quality are improved.

Note that that provision of the first/second processing instruction shall not be understood in a narrow way formed by a simple addition of the first intermediate network data and the copy of the second intermediate network data in the first hearing device. The provision may comprise a more elaborate or merging scheme, for example a weighted merging, also referred to as mixing, for example. As one can see, the step of providing the first processing instruction or the second processing instruction involves a creation, i.e., an establishment of the processing instruction by way of a calculation process.

Note that at least the steps of generating the intermediate network data and the step of providing in the neural networks the processing instructions based on the local intermediate network data and the copy of the intermediate network data received from the contralateral hearing device need to be carried out in the neural network.

If one wants to profit maximally from the inventive method, it is best if the binaural system is a fully binaural system where not only the copy of one intermediate network data is considered but where both copies of the intermediate network are considered. Such as solution is hereinafter referred to as a fully binaural hearing system solution. To profit from a fully binaural system, the relevant requirement resides in that its neural networks can perform the method disclosed herein and that the hearing devices can both exchange the intermediate network data disclosed herein.

In such a method, step d) of the basic embodiment explained above further comprises a transmitting of a copy of the first intermediate network data from the first hearing device to the second hearing device while maintaining the first intermediate network data in the first hearing device. Moreover, the provision of the second processing instruction in the second neural network in step e) of the basic embodiment explained above is based on the second intermediate network data and the copy of the first intermediate network data received from the first hearing device.

Again, the term “providing the processing instruction” does not necessarily imply that the second intermediate network data and the copy of the first intermediate network data are simply added in the second neural network. There can be again a weighted merging, also referred to as a mixing, for example. In some examples, a similar kind of data merging is implemented in both hearing devices provided that the hearing devices are of the same type.

In a hearing system that performs such a method, the end user can profit from an optimal hearing impairment compensation right away when she/he receives a pair of such hearing devices that are capable of operation according to the present method without requiring a full training of all sound scenarios the end user is experiencing.

Based on the meta-data of the enhancement network, i.e., the first and second intermediate network data, a preliminary interference masks (i.e., the first/second processing instructions) of the first and the second hearing device are combined to form a first/second processing instruction that is applied to one or both audio signals thereafter. Such a mask can be a complex ratio mask that causes a change in every frame, and that is applied to the signal of the audio input eventually.

The first/second intermediate network data is used to improve the spatial acoustic quality at the time of calculating the sound processing parameters. In case of a noise reduction, for example, the SNR can be improved in a binaural system compared to a system with two ipsilaterally operated hearing devices that perform the noise reduction independent from one another.

Note that the sharing of the first/second intermediate network data is not to be confused with computational job sharing, an exchange of sound classifiers, device modes or the like. The data size of the neural network-generated noise reduction data sets contained in the intermediate network data exchanged between the hearing devices can be lower than exchanging audio data between the hearing devices.

Also note that the first/second intermediate network data is not restricted to comprising noise reduction information. The intermediate network data can also contain information relating to a soft speech enhancement, like soft speech enhancement or gain shape adjustment for example. In embodiments of the methods, the first/second intermediate network data contain information relating to noise reduction as well as to speech enhancement as well as further information that is suitable to modify the output signal, each.

It is beneficial to the overall performance of the binaural hearing system if the first binaural cue, and in some examples also the second binaural cue comprise at least one member of the following group, each:
an interaural level difference (ILD),
an interaural time difference (ITD),
a correlation between the first acoustic audio input at the first hearing device and a second acoustic audio input at the second hearing device,
a speaker location relative to the head of the end user wearing the first hearing device and the second hearing device,
a magnitude of a signal, (can be noise and/or speech)
a phase of a signal,
a modulation of a signal.

Please note that the ITD, ILD and the speaker location, for example, can be manually treated data. There is no strict need that this is data from a neural network.

In case that the transmitting density or frequency is limited, it is possible to reduce the size of the data packages that are exchanged between the first and the second neural network by the additional step of compressing and/or encoding the copy of the second intermediate network data, and, in some examples, also the copy of the first intermediate network data, prior to the data transmission. In such an embodiment, there will be an additional step of decompressing and/or decoding the copy of the second intermediate network data and the copy of the first intermediate network data prior after receiving the intermediate network data. The compressing/encoding and the decompressing/decoding of the intermediate network data can be performed outside the neural network, if required.

In an exemplary embodiment, the data compression comprises a data packaging. A suitable transfer protocol is Bluetooth, for example. However, other transfer protocols, including proprietary ones can be used as well.

Since the data compression lowers the amount of data to be exchanged, a reduction of the power consumption is achievable.

A further advantage residing in a speaker identification with respect to a speaker position in a room is available, if the first hearing device and the second hearing device have two primary microphones, each. Such an embodiment is also beneficial in that it allows for using the established beamformer technology.

In more advanced hearing systems that are suitable for the partial as well as the fully binaural system, it is possible to selectively switch off the transmission the copy of the intermediate network data from the first hearing device to the second hearing device and vice versa. An exemplary reason for such a selective switch off of the transmission function can reside in that the power (battery) status of the hearing device is running low. In such a case, a pre-programmed logic may take the decision to switch off the intermediate network data transmission to save electric power for the core function of the hearing device, instead. Being unable to profit from the mitigation of the effect of spatial artifacts in an acoustic signal in a binaural hearing system is less severe to the end user than having a non-operating hearing device for the remainder of her/his regular day. In such an embodiment, it will be beneficial if the first and the second neural networks were also trained on how a regular day of the end user typically looks like such that an anticipation of the power consumption can be calculated ahead. Another reason for switching off the intermediate network data transmission may reside in that a predefined low power threshold is achieved where all functionalities requiring a higher power consumption such as neural network-functions are switched off. Neural network computation is by many orders of magnitude more computation intensive and data intensive than classical audio signal processing. This restricts the usability of neural network processing of signals in hearing devices.

To ensure a top performance of the hearing system to the end user, it is highly recommendable to synchronize in the first hearing device the first intermediate network data that is based on the first audio input at a moment “t1” in time with the copy of the second intermediate network data that is based on the second audio input from the same moment “t1” n time. Both the first intermediate network data and the copy of the second intermediate form the input for the step of providing the first processing instruction. Such a method is suitable for the partial as well as the fully binaural system.

Likewise, it is recommendable to synchronize in the second hearing device the second intermediate network data that is based on the second audio input at a moment “t1” in time with the copy of the first intermediate network data that is based on the first audio input from the same moment “t1” n time. Both the second intermediate network data and the copy of the first intermediate form the input for the step of providing the second processing instruction.

The lower the time, local intermediate network data needs to be buffered until the received intermediate network data is available, the lower the latency of the hearing system and the more natural the output signal of the hearing devices to the end user is. A use of time keys to buffer and sync signals in hearing devices is known in the art.

The buffering of the locally produced intermediate network data is done for the same amount of time (period) that is required for the preliminary analysis and data exchange between the hearing devices.

Moreover, an optimization of the data and/or electric power consumption in the hearing system is available if the transmitting of the copy of the second intermediate network data to the first hearing device, and, in some examples, also the transmitting of the copy of the first intermediate network data to the second hearing device are frequency dependent.

It is possible to process the time-frequency bin separately in every frequency band.

An available option of the hearing system and its operating method is available for cases, where a certain amount of unprocessed digital signal shall bypass the signal processing in the neural networks, each. An advantage of such an embodiment can reside in that the sound perception of a sound is regarded as more natural by the end user than if all input signal undergoes the digital signal processing in the neural networks.

In such an exemplary embodiment, there will be the additional steps of
splitting a first audio signal and a second audio signal corresponding to the first audio input and the second audio input, respectively, before generating the first intermediate network data and the second intermediate network data, each, such that a branched-off part of the first audio signal and a second audio signal is bypassing the generation of the first intermediate network data and the second intermediate network data, respectively, and
merging the audio signals resulting of the signal processing conducted by applying the first processing instruction to the first audio input at the first hearing device, and by applying the second processing instruction to the second audio input at the second hearing device, if available, with the above-mentioned branched-off and bypassed audio signal, each. The merging is controlled by a selectable weighting of the branched-off and bypassed audio signals and the audio signals from the neural networks.

Since it is desirable by the end users to have an advantageous SNR, it is sensible to train the first and second neural networks such that they can reduce the amount of acoustic noise in the processed signal at the same time. In an exemplary embodiment, the second intermediate network data and, in some examples, the first intermediate network data, if available, too, comprise information that contributes to reducing acoustic noise of the second audio input and the first audio input, respectively, when conducting the signal processing by applying the first processing instruction to the first audio input at the first hearing device, and the second processing instruction to the second audio input at the second hearing device.

In case of a fully operating binaural network, both the first as well as the second binaural cues comprise noise reduction information.

In an exemplary embodiment, the information that is deployable to reduce acoustic noise can be a noise reduction code that is obtained from a look-up-table by the neural networks to derive the complete (uncodified or still codified) set of instructions.

There can be reasons where one prefers an embodiment where the intermediate network data that is locally available in the neural network and the copy of the intermediate network data of the neural network from the contralateral hearing device are not simply added to form the signal input for the subsequent first/second processing instruction but only considered to a certain extent. Such a method is suitable for the partial as well as the fully binaural system. In an exemplary embodiment, there is at least a basic quality check of the copy of the intermediate network data received. In its most basic form, the basic check result may be a “0” if no copy of the intermediate network data is received, or a “1” if the copy of the intermediate network data is received. Other plausibility checks may take place, if necessary. A plausibility check may be performed to detect if the copy of the intermediate network data received is defective or corrupt or even missing, for example because there was a drop-out or temporary breakdown of the transmission functionality.

Hence, in an exemplary embodiment, the copy of the second intermediate network data is considered by the first neural network to a first extent, wherein the first extent is based on a signal quality of the copy of the second intermediate network data received. The copy of the first intermediate network data, if available, is considered by the second neural network to a second extent, wherein the second extent is based on a signal quality of the copy of the first intermediate network data.

The first/second extent can be a weighting factor or an entire discarding of the copy of the first intermediate network data by the second hearing device and the copy of the second intermediate network data by the first hearing device for the step of providing the second and the first processing instruction, respectively. The consideration of the first/second extent when providing the second/first processing instruction is such that the second/first copy of the intermediate network signal is only taken into account to a minimal or even no extent at all only when providing the first/second processing instruction, each. In other words, there can be some predefined thresholds above which one extent shall be applied and below which, yet another extent shall be applied.

As mentioned above, it will be decisive to the performance of the hearing system and the method applied, how the neural networks are trained. Hence, more detailed explanation to the training method is provided hereinafter.

In a basic training method for training the first neuronal network and the second neuronal network, the algorithms stored in the neural network provided in both the first hearing device and the second hearing device, each, have been trained with a plurality of spatialized datasets.

A spatialized datasets is a dataset that is based on acoustic audio inputs that is fed to two microphones of two hearing devices simultaneously (stereo sound). Such datasets having a four-channel information where each channel represents one microphone are not common in the hearing device industry up to now, if they are available in a high number and with variations such that they are sufficient to train a neural network at all. The spatialized datasets comprise stereo sounds with digitized multi-channel audio data including meta-data on the speaker location, for example. These spatialized datasets are specifically designed to train the neural networks. Each neural network training dataset was designed with a specific goal in mind. In an exemplary embodiment, the training dataset needs to have multichannel audio input on which the neural networks can be trained. It is possible to use synthesized spatial information to train the neural networks.

In hearing devices that commonly have a very limited amount of electric power available only, a strict power management is highly recommended, if not compulsory. Running a neural network in a hearing device is a power-intensive application. Hence, it is advisable to implement a smart power management that is able to draw a balance between the strict requirement for running some functionalities and the performance of a hearing device and optional situations where some functionalities are rather a nice-to-have and can be applied only if there is sufficient electric power available.

In an exemplary embodiment, the method employs a cost function that is as follows: At least one of an interaural level difference (ILD) and an interaural time difference (ITD) measured between a first audio signal and a second audio signal corresponding to the first acoustic audio input and the second acoustic audio input, respectively, and the signal output after the application of the first processing instruction to the first audio input at the first hearing device and the second processing instruction to the second audio input at the second hearing device, respectively, forms the cost function that was derived during a training phase of the neural network for the neural networks.

That cost function serves as a crucial metric, evaluating the performance of the neural network on a given task. The binaural system enables the selection of the correct cost function.

Example: The neural networks learn during the training phase that the information of the sixth node on the fourth layer has an optimal value since it leads to the best outcome after the step of conducting a signal processing by applying the first and/or second processing instruction. The ILD and ITD are metrics. There are several metrics available. Some metrics are more suitable for training the DNN on certain acoustic benefits than other. For example, non-intrusive deep learning-based computational speech metrics (QMetrics) are suitable for evaluating a monaural DNN with no binaural information because the QMetrics was designed for that purpose. QMetrics does not evaluate spatial attributes and is thus not suitable for evaluating improvements in spatial artefacts.

Having a suitable cost function in place is important because a main goal of any neural network resides in making accurate predictions. A cost function helps to quantify how far the neural network's predictions are off from the actual values. It is a measure of the error between the predicted output and the actual output. During the training process, the neural network adjusts its weights and biases to minimize the cost function. The goal is to find a minimum value of the cost function, which corresponds to the best set of weights and biases that are required to make accurate predictions.

In an exemplary embodiment, at least one of the following types of a cost function is implemented: a) Mean Squared Error (MSE); b) Binary Cross-Entropy; c) Categorical Cross-Entropy.

Another cost function is the frequency, i.e., the number of times the intermediate network data is exchanged between the hearing devices. The frequency directly affects the power consumption. In an exemplary embodiment, the provision of another cost function residing in that at least one of the first neural network and the second neural network is configured such that it controls an exchange rate for the transmission of the copy of the first intermediate network data and the second intermediate network data set, respectively.

The exchange rate can depend on the situation, for example if it confers the end user with a big benefit. The cost function only plays a role if the neural networks are up and running. An exchange of intermediate network data from one hearing device to the contralateral hearing device is more often, if a sound scene is asymmetric. Asymmetric denotes the share of the sound arriving at the left ear hearing device compared to the sound arriving at the right ear hearing device. See U.S. Pat. No. 9,439,004B2 for more detail hereto.

What type, content and what amount of data shall be transmitted to the contralateral hearing device will be determined during the training phase of the neural networks. The same applies to the timing, i.e., to when or what moment in time the intermediate date shall be sent.

There are several embodiments of a cost function conceivable. In an even more advanced embodiment, the provision of yet another cost function is made that comprises a balance between at least one of the group comprising:
a) a minimal power consumption of the hearing device;
b) a maximal binaural noise suppression;
c) a minimal amount of binaural artefacts.

A hearing system comprising a first hearing device and a second hearing device that are configured such that they are capable to perform the method as described above will profit from the benefits mentioned above.

The above description has many options that may be picked and merged with one another to form a binaural hearing system or a training method for training the first neuronal network and the second neuronal network. Such methods will profit from the benefits mentioned in their related sections accordingly.

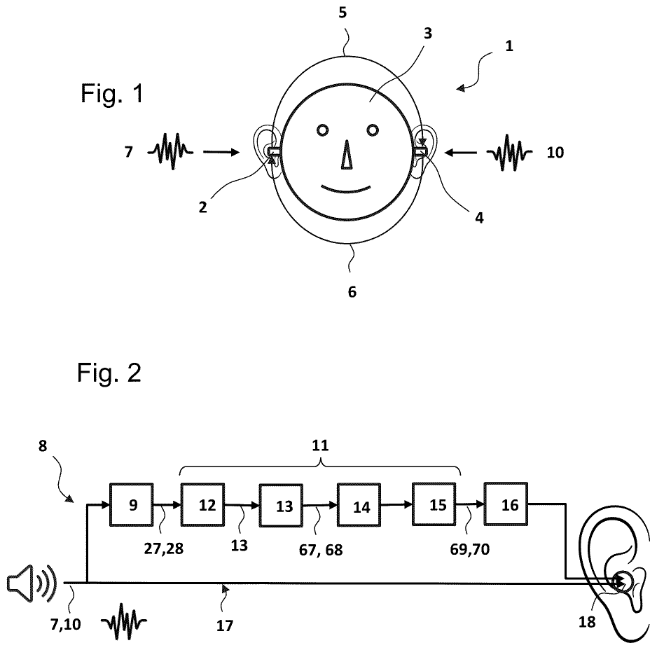

FIG. 1 depicts a binaural hearing system 1 in operation. A first hearing device 2 is located at the right ear of the end user 3 while a second hearing device 4 is located at the right ear of the end user 3. A transmission of a copy of the intermediate network data from the first hearing device 2 to the second hearing device 4 is denoted by arrow 5 while a transmission of a copy of the intermediate network data from the second hearing device 4 to the first hearing device 2 is denoted by arrow 6.

FIG. 2 depicts a simplified and generic diagram of coupling an acoustic input signal (here an emission of a loudspeaker) to the ear canal 18 of the end user of the hearing device. In the processed sound path 8, the acoustic input audio signal emitted by the loudspeaker is first received by a microphone 9, then converted into an electronic signal referred to as audio input signal 27, 28 hereinafter and processed in a signal processing sequence 11 to compensate for the hearing loss of the end user 3 at least in part. In the present embodiment, the signal processing sequence 11 involves a sound strength adjustment 12 (gain adjustment), followed by a noise reduction 13, a speech enhancement 14 and a further sound tuning (e.g., a filtering) 15, followed by emitting by way of a receiver 16 that converts the output signal back into acoustic sound that is led into a section of the ear canal 18 located after the custom shell 30 and before the eardrum.

In the present illustrative example, the hearing device is of Receiver-In-Canal (RIC) type with an earpiece in the form of a dome (not shown). The dome is a rubbery-type shell element such as known from WO2023/051008A1, for example. In other examples, the earpiece may comprise acryl, titanium or a silicone. Reference character 17 denotes the direct sound path along which the acoustic audio input 7, 10 (direct audio signal) travels from the sound source via the vent channel of the earpiece of the hearing device into the ear canal 18 towards the eardrum.

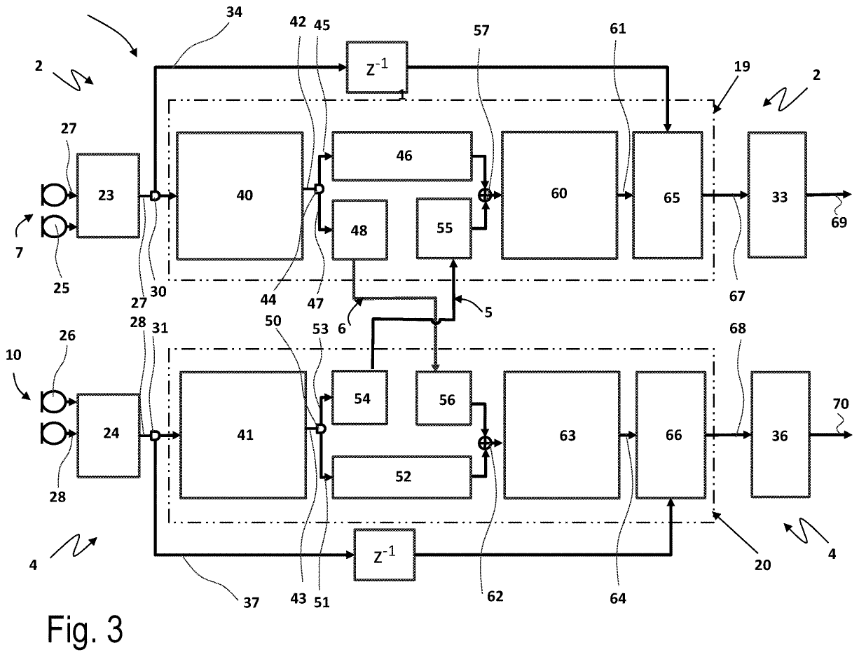

FIG. 3 depicts the organization of the sound processing in a binaural hearing system where both neural networks receive the intermediate network data from the contralateral hearing device. Compared to FIG. 2, the flowchart comprises a first neural network 19 and a second neural network 20 dedicated to both a first hearing device 2 and a second hearing device 4, each. Processes like the sound strength adjustment 12 and further possible pre-processing activities are summarized in a first preprocessing 23, 24, each. Each hearing device 2, 4 has two primary microphones 25, 26, each, as that assists in using beamformers and that convert the first acoustic audio input signal 7 and the second acoustic audio input signal 10 into first and second audio inputs 27, 28, each. In FIG. 2, those microphones 25, 26 correspond to the functional block 9. However, that beamformer functionality is well known and does not need to be explained in this disclosure. These primary microphones 25, 26 convert the first and second acoustic audio input 7, 10 into a first and a second audio input 27, 28, each. The first audio input 27 and the second audio input 28 are digital signals, each.

Once the first audio input 27 and the second audio input 28 leaves the preprocessing units 23, 24, the signal is different to the first audio input 27 and the second audio input 28 compared to the first audio input and second audio input entering the preprocessing units 23, 24. For the sake of keeping this description as simple as possible, the output signal leaving the preprocessing units 23, 24 is hereinafter still referred to as first audio input 27 and second audio input 28, respectively. it is split by a first splitter 30 and a second splitter 31, respectively. A first branch of the split first audio input 27 is led through the first neural network 19 while a second branch 34 of the split first audio input 27 is bypassing most steps of the first neural network 19 and is reunited at the last step in the first neural network 19 residing in conducting a signal processing by applying the first processing instruction to the first audio input that was branched off at the first splitter 30. Likewise, a first branch of the split second audio input 28 is led through the second neural network 20 while a second branch 37 of the split second audio input 28 is bypassing most steps of the second neural network 20 and is reunited at the last step in the second neural network residing in conducting a signal processing by applying the second processing instruction to the second audio input that was branched off at the second splitter 31.

To compensate for a time delay caused by the provision of the first processing instruction 61 and the second processing instruction 64 in the first neural network 19 and the second neural network 20, respectively, the audio-input signals 27, 28 in the bypassed second branches 34, 37, each, are delayed such that they are brought in sync. That delay is indicated by the reference character z⁻¹. The synchronization ensures that the processing instruction that was created based on audio input received at a moment in time t1 is actually applied to the audio input received at that precise moment in time t1.

Last, the output signals 67, 68 of the first and second neural networks 19, 20, each, are fed in the example shown in FIG. 3 to a postprocessing unit 33, 36, each, for further sound tuning such as a filtering as indicated by reference character 15 in FIG. 2.

Before explaining how the neural networks 19, 20 works, some explanation about the architecture and set up as well as the training of the neural network is provided below.

The neural networks have some input that undergoes a plurality of mathematical operations until it is outputted. Examples of neural network structures for audio signal processing combine layers of different types of neural networks, namely convolutional neural networks (CNN) and recurrent neural networks (RNN). Different types of neural network architectures have different demands on computing and data throughputs. A U-Net architecture uses RNNs and CNNs, where the RNN network part is used to store some history data (states). There are several options available to develop an optimal hybrid neural network. Hence, there is no specific amount of CNN layers/convolutions and RNN layers indicated here. An exemplary neural network may comprise a CNN-type encoder module, an RNN-type bottleneck module and a CNN-type decoder module that are executed sequentially. Skip connections assist the training of the neural network. In an exemplary embodiment, the present neural network has also skip links/connections between layers of the encoder and layers of the decoder.

As always, there is an iterative process required to arrive at an optimal network architecture. Training metrics for the cost functions are directed to the functional performance as well as to the computational cost. For example, the performance measure may include metrics such as speech intelligibility index, perceptual evaluation of speech quality (PESQ), speech transmission index (STI), mean opinion score, etc., while the parameters may include weights for neural networks for encoders and combinators. In some examples, a performance measure module may also be implemented using a machine learning algorithm, such as a neural network.

The neural network may comprise one or more hidden layers being arranged in between the input layer and the output layer. Generally, a neural network may comprise different functional modules. For example, a neural network may be configured to extract features from an audio signal and to further process the audio signal based on the extracted features.

As such, known hardware structures for accelerating neural network processing do not suffice to efficiently compute all different layers of a complex neural network. A known workaround is to run processing units for neural networks at very high clock rates to compensate for their less efficient hardware structure. This is however no option for hearing devices which do not bring sufficient computational power and battery capacity for consistently running processing units at high clock rates.

The neural network chosen for an exemplary noise reduction application has a U-Net architecture with both CNN and RNN layers and is able to predict a complex-valued ideal ratio mask from the short-time Fourier transform (STFT) of noisy speech signals/spectrums. In this architecture, the encoder may receive preprocessed audio signals from a preprocessor and generate an intermediate signal representation (ISR) corresponding to the preprocessed audio signals and forming the intermediate network data. The ISR may also be configured with a threshold complexity so that the ISR may be transmitted efficiently, such as via a low-latency wireless connection or any such suitable connection (e.g., wireless communication link). Thus, the ISR may be implemented as any suitable latent representation of the audio signals, such as a signal that encodes the audio signals received by encoder with a lower dimensionality than the audio signals. For instance, the ISR may be a sparsely encoded (e.g., an encoding of data comprising mostly zeros relative to non-zeros) non-audio signal that corresponds to a combination of the preprocessed audio signals. There are skip connections between the layers of the encoder and the layers of the decoder.

A U-Net is trained by at least a few ten thousand hours of noisy speech to enhance the speech signal and mask unwanted background noise contained in the input audio signal using a mean-squared error loss. In defining the training data samples (datasets), it is possible to replace one kind of input data with a different, non-matching kind of input data to obtain an erroneous input data. It is also possible to use some kind of measurement data and combine it with noise, such as white noise. It is also possible to by taking a data sample, in particular a signal having a high SNR, and add or multiply that data sample or an input value derived therefrom by a random number during training. Data sets with spatialized sound samples can used to train the neural network that is optimized to send and receive ISR from the contralateral side. A specific use case is to improve the binaural quality for a speech in noise task. In this case, a multitude of different noise conditions would be mixed with clean speech at different SNRs. Noises could include restaurant noise, traffic noise, and any other noise that could occur during conversations. Noise and speech samples can be mixed among each other to cover a wider field of variations. Each mixed sample can be tested with and without applying the method to mitigate the effect of spatial artifacts in the acoustic signal in the binaural hearing system. Therefore, neural network is trained with spatialized datasets comprising four-channel sound, speech only, and comprising the same speech mixed with various background noise of different type and intensity. The desired output (prediction) of the neural network should be as close as possible to the dataset with the speech only such that an optimal SNR is obtained (ideal label). The model in the neural network contains a weighting of training data, the speech quality, the total sound quality, and the amount of useful noise reduction to arrive at an optimal SNR with a low level of sound artifacts, including spatial artefacts only. As a result, the processed audio signal leaving the neural networks contains less audio noise such that the end user can understand a spoken message contained in the acoustic audio input better than if there was no noise reduction, while preserving spatial sound quality.

Neural network parameters refer to any information which characterizes the state of the neural network, particularly the internal state of the neural network. Neural network parameters may comprise neural network states, network weights, neural network features and/or activation functions.

A challenge for neural network-based denoising/noise-reduction algorithms is their computational cost compared to noise reduction methods traditionally used in hearing devices. As with most deep learning-based systems, the performance of the selected network improves with the available computational resources. To optimize the exemplary mentioned U-Net architecture, an evolutionary architecture can guide the search for an optimal neural network. The denoising network is trained to predict noise-reduced outputs from mixed speech and noise input STFTs, while preserving spatial quality. To optimize the remaining error for human acoustic perception, the denoising network architecture and hyperparameters are selected by an evolutionary neural architecture search. This search is guided by an MOS estimator, which is a deep neural network trained on a dataset generated from human-rated audio files or other objective metrics related to speech in noise performance and spatial quality.

An optimal cost function can be derived by way of the gradient descent method that serves to find the minimum of a mathematical function iteratively and fast. A residual risk of missing global minima but getting stuck with local minima is addressed by manual adjustment. The training can also require a manual adjustment of initial weights, values of the matrices and vectors. Loss functions minimizing binaural cue distortion may regulate one or more of the following properties: interaural intensity difference (IID, also referred to as interchannel intensity difference), interaural phase difference (IPD, also referred to as interchannel phase difference), interaural coherence (IC, also referred to as interchannel coherence), and overall phase difference (OPD). Suitable loss functions and training methods are described in B. Tolooshams and K. Koishida: “A Training Framework for Stereo-Aware Speech Enhancement using Deep Neural Networks”, arXiv: 2112.04939v2, 31.01.2022.

The processing chip of the neural networks 19, 20 comprises a first compute unit having a hardware architecture adapted for processing one or more convolutional neural network layers of the at least one neural network, a second compute unit having a hardware architecture adapted for processing one or more recurrent neural network layers of the at least one neural network, a control unit for directing the first compute unit and the second compute unit when to compute a respective layer of the at least one neural network, a shared memory unit for storing data to be processed in respective layers of the at least one neural network, and a data bus system for providing access to the shared memory unit for each of the first compute unit and the second compute unit.

The processing chip combines specific hardware for processing different architectures of neural networks, for example CNNs and RNNs. As such, respective layers of at least one neural network can be efficiently computed on the processing chip, improving possible use cases of complex neural network processing on hearing devices. Particularly advantageous, the shared memory unit stores data to be processed by the respective layers directly on the chip. As such, the compute units can access respective data directly on the chip, in particular exchange data via the shared memory unit. Exchanging data via or loading input data from off-chip memory and respective delays are avoided. The data bus system allows for an efficient and fast data exchange between the compute units and the shared memory unit. The processing chip/processor can include special-purpose hardware, such as application-specific integrated circuits (ASICs), programmable logic devices (PLDs), field-programmable gated arrays (FPGAs), programmable circuitry (e.g. one or more microprocessor microcontrollers), digital signal processors (DSPs), appropriately programmed software and/or computer code, or a combination of special purpose hardware and programmable circuitry. Summing up, the processor comprises hardware adapted for processing neural networks, for example an AI chip.

For the buffering of information, any suitable data memory can be used. Exemplary data memories include, but are not limited to, dynamic random-access memories (DRAM), static random-access memories (SRAM), random access memories (RAM), solid state drives (SSD), hard drives and/or flash drives.

The algorithm of the method according to this disclosure can run in real-time on Ubuntu 16.04 on an Asus FX504GD-DM116 laptop with the following specifications: Intel Core i5-8300H, 8 GB DDR4 RAM, and a NVIDIA GTX 1050 graphics card, for example.

Last note that a multiplexing of the neural networks does not contravene the gist of the present disclosure.

Now let us revert to the neural networks 19, 20 and how they work once they are trained in more detail. The neural networks on the neural network 19, 20 work in two phases which is illustrated by blocks in FIG. 3. The blocks in the neural networks 19, 20 denote activities, not the signals.

In a first phase, a feature extraction is performed. That feature extraction is used to generate the intermediate network data. That intermediate network data contains information of the first few layers of the encoder. Since both the first hearing device 2 and the second hearing device 4 have such a feature extraction, both have a generation of intermediate network data. There is a generation of first intermediate network data 42 in the first neural network 19 and a generation of second intermediate network data 43 in the second neural network 20.

Since the first audio input 27 and the second audio input 28 can vary to one another, we distinguish between the first intermediate network data 42 leaving the generation block 40 (first encoder) in the first neural network 19 and the second intermediate network data 43 leaving the generation block 41 (second encoder) in the second neural network 20.

The signal path with the first intermediate network data 42 is then split by a third splitter 44 into a first local path 45 that leads to a first buffer 46 and to a branch leading to the transmission of the first intermediate network data 42 to the second neural network 20. To distinguish the content of the two branches better from one another, the signal that is transmitted to the second neural network 20 is referred to as a copy of the first intermediate network data 47 while the term first intermediate network data 42 is used for the signal that is kept locally within the first neural network 19 until the first processing instruction is created. However, the content of the first intermediate network data 42 and the copy of the first intermediate network data 47 is the same. The first neural network 19 has a functional first transmission block 48 that handles the copy of the first intermediate network data 47. In an alternative embodiment (not shown), the transmission block handling the copy of the first intermediate network data is provided outside the first neural network in the first hearing device 2.

Likewise, the signal path with the second intermediate network data 43 is then split by a fourth splitter 50 into a second local path 45 that leads to a second buffer 52 and to a branch leading to the transmission of the second intermediate network data 43 to the first neural network 19. To distinguish the content of the two branches better from one another, the signal that is transmitted to the first neural network 19 is referred to as a copy of the second intermediate network data 53 while the term second intermediate network data 43 is used for the signal that is kept locally within the second neural network 20 until the second processing instruction is created. However, the content of the second intermediate network data 43 and the copy of the second intermediate network data 53 is the same. The second neural network 20 has a functional second transmission block 54 that handles the copy of the second intermediate network data 53. In an alternative embodiment (not shown), the transmission block handling the copy of the second intermediate network data is provided outside the second neural network in the second hearing device 4.

Next, the intermediate network data of each hearing device is shared with the contralateral hearing device. That is done via streaming by Bluetooth classic in the present example. However, other transmission protocols are equally suitable as long as the latency of the hearing system can be kept as low as possible in an operating state of the hearing system.

The copy of the second intermediate network data 53 is then received by a first reception block 55 located in the first neural network 19. Again, the reception block handling the copy of the second intermediate network data may be provided outside the first neural network in the first hearing device 2 as long as the copy of the second intermediate network data is fed to the first neural network 19 for further processing.

The copy of the first intermediate network data 47 is then received by a second reception block 56 located in the second neural network 20. Again, the reception block handling the copy of the first intermediate network data may be provided outside the second neural network in the second hearing device 4 as long as the copy of the first intermediate network data is fed to the second neural network for further processing.

Next, the second phase of the neural network process is performed. For that purpose, the first intermediate network data 47 and the copy of the second intermediate network data 53 are merged by a third adder 57 to form an input for the first provision block 60 (a decoder) in which the first processing instruction 61 is generated and provided for further use. In the example shown in FIG. 3, the copy of the second intermediate network data 53 is considered by the first neural network 19 to a first extent. Said first extent is based on a signal quality of the copy of the second intermediate network data 53 received. In the present embodiment, there is a basic quality check of the second intermediate network data 53 only. An availability check, so to say. Since the copy of the second intermediate network data 53 is present, the first extent has a value of 1. When creating the first processing instruction 61, a mixing ratio that is achieved by a weighting of the first intermediate network data 42 and the copy of the second intermediate network data 53 received from the second hearing device in the third adder 57. Since the first extent has a value of 1, the copy of the first intermediate network data 42 and the second intermediate network data 53 are merely added to one another with an equal weight.

Likewise, the second intermediate network data 43 and the copy of the first intermediate network data 47 received are merged by a fourth adder 62 to form an input for the second provision block 63 (a decoder) in which the second processing instruction 64 is generated and provided for further use. Also here, the copy of the first intermediate network data 47 is considered by the second neural network 20 to a second extent. Said second extent is based on a signal quality of the copy of the first intermediate network data 47 received. In the present embodiment, there is a basic quality check of the first intermediate network data 47 only. An availability check, so to say, again. Since the copy of the first intermediate network data 47 is present, the second extent has a value of 1, too. When creating the second processing instruction 64, a mixing ratio that is achieved by a weighting of the second intermediate network data 43 and the copy of the first intermediate network data 47 received from the first hearing device in the fourth adder 57. Since the first extent has a value of 1, the copy of the first intermediate network data 42 and the second intermediate network data 53 are merely added to one another with an equal weight.

The last step in the embodiment of the hearing system shown in FIG. 3 resides in conducting in a first conduction block 65 of the first neural network 19 a signal processing by applying the first processing instruction 61 to the first audio input 27 at the first hearing device 2. Likewise, there is a conducting step in a second conduction block 66 of the second neural network 20 where a signal processing by applying the second processing instruction 64 to the second audio input 28 at the second hearing device 4. In the present example, the intermediate network data 42, 43 and the transmitted copies of the intermediate network data 47, 53 contained information relating to a noise reduction and to improve the SNR in the output signal of the hearing devices 2, 4. Hence one can interpret the neural networks 19, 20 as functional unit 13 shown in FIG. 2. The algorithms of the processing instructions 61, 64 restores speech intelligibility for the end user to the level of control comparable to a person with normal hearing.

Note that the signals form the functional blocks 40, 48, 46, 55 and 60 only make use of the first audio input 27 but eventually just create a first processing instruction 61. Thus, strictly speaking, these functional blocks are not in the sound processing path as in the end, it is only at the first conduction block 65 of the first neural network 19 where a true signal processing of the first audio input 27 is performed by applying the first processing instruction 61 leading to an output signal 67 for the end user.

Likewise, the signals form the functional blocks 41, 54, 52, 56 and 63 only make use of the second audio input 28 but eventually just create a second processing instruction 64. Thus, strictly speaking, these functional blocks are not in the sound processing path as in the end, it is only at the second conduction block 66 of the second neural network 20 where a true signal processing of the second audio input 28 is performed by applying the second processing instruction 64 leading to an output signal 68 for the end user.

As mentioned before, the output signals 67, 68 of the first and second neural networks 19, 20, each, are fed in this example to a postprocessing unit 33, 36, each, for further sound tuning such as a filtering, for example. The signals that leave the postprocessing unit 33, 36, each, are denoted as first resulting signal 69 and as second resulting signal, respectively. That resulting signals 69, 70 are then fed via Litz cables out of the BTE part housing the content of the hearing devices, each, shown in FIG. 3 to a receiver provided in the dome, each, where the resulting signals 69, 70 are converted to audio sound that is fed to the eardrums of the end user 3.

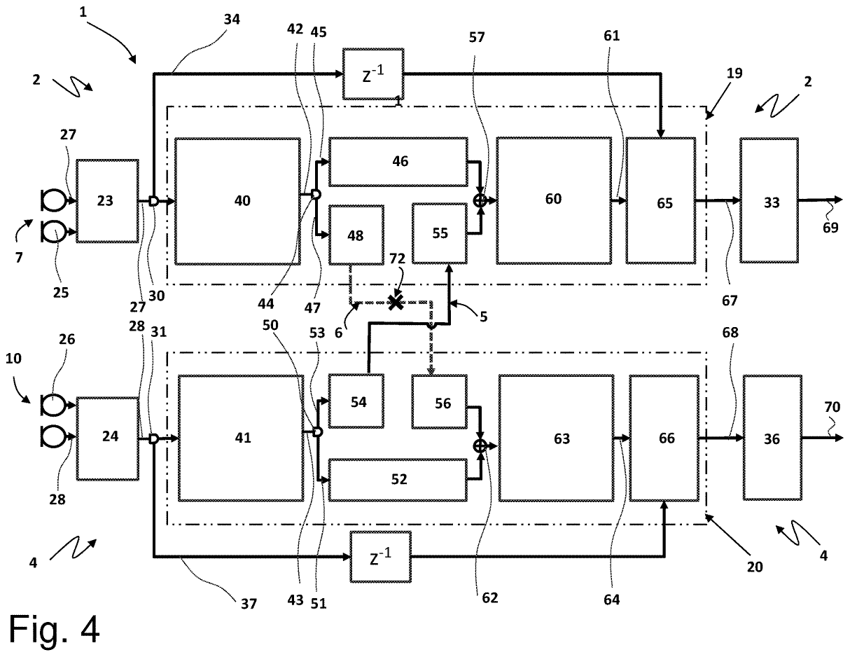

FIG. 4 shows the same architectural and functional hearing system as shown and described with respect to FIG. 3. Hence, a repetition of the reference characters and the function of their depicted features is omitted. The difference of the embodiment shown in FIG. 4 to the one in FIG. 3 resides in that the exemplary organization of the sound processing in a binaural hearing system where only the first neural network 19 receives the copy of the second intermediate network data 53 from the contralateral second hearing device 4. The second neural network 20 does not receive the copy of the first intermediate network data 47 from the contralateral first hearing device 19. Let us assume an exemplary reason on why there is no copy of the first intermediate network data 47 available at the second reception block 56 resides in that there is a defect in the second reception block 56. The disrupted transmission of the copy of the first intermediate network data 47 to the second reception block 56 is indicated by a cross 72 denoting the unavailability of the copy of the first intermediate network data 47. That is why transmission path 6 is displayed with a dotted line in FIG. 4.

Since the first reception block 55 is receiving the copy of the second intermediate network data 53. Hence, the first processing instruction 61 is provided in the first neural network 19 based on the first intermediate network data 42 and the copy of the second intermediate network data 53.

Different thereto is the second processing instruction 64 is provided in the second neural network 20 based on the second intermediate network data 43 only, since the copy of the first intermediate network data 47 is missing. Enabling a generating and providing the second processing instruction 64 even in case the copy of the first intermediate network data 47 is missing is important to ensure that the end user receives a resulting signal 70 from the second hearing device 4, even if it is not perfect.

As a fallback position, although not a favored one, the second hearing device 4 may also generating and providing the second processing instruction 64 even in case the local second intermediate network data 43 is unavailable but where the copy of the first intermediate network data 47 and the second audio input 28 are available. Such a solution is still favored over having no resulting signal 70 from the second hearing device 4 at all.

Although the interruption of the transmission of the copy of the first intermediate network data 47 was explained in the context of FIG. 4 only, it is evident that the same functionality holds true likewise in the reverse situation where the copy of the second intermediate network data 53 is not received by the first reception block 55 accordingly.

### LIST OF REFERENCE SYMBOLS

1 binaural hearing system
2 first hearing device
3 end user
4 second hearing device
5 transmission of a copy of the intermediate network data from the first hearing device
2 to the second hearing device 4
6 transmission of a copy of the intermediate network data from the second hearing device 4 to the first hearing device 2
7 first acoustic audio input signal
8 processed sound path
9 microphone
10 second acoustic audio input signal
11 signal processing sequence
12 sound strength adjustment
13 noise reduction
14 speech enhancement
15 further sound tuning
16 receiver
17 direct sound path
18 ear canal
19 first neural network/first neural network unit
20 second neural network/second neural network unit
23 first preprocessing
24 first preprocessing
25 first set of primary microphones
26 second set of primary microphones
27 first audio input
28 second audio input
30 first splitter
31 second splitter
33 first postprocessing unit
34 second branch of the splitted first audio input 27
36 second postprocessing unit
37 second branch of the splitted second audio input 28
40 generation block (first encoder)
41 generation block (second encoder)
42 first intermediate network data
43 second intermediate network data
44 third splitter
45 first local path
46 first buffer
47 copy of the first intermediate network data
48 first transmission block
49 second local path
50 fourth splitter
52 second buffer
53 copy of the second intermediate network data
54 second transmission block
55 first reception block
56 second reception block
57 third adder
60 first provision block (decoder)
61 first processing instruction
62 fourth adder
63 second provision block (decoder)
64 second processing instruction
65 first conduction block
66 second conduction block
67 output signal of the first neural network 19
68 output signals of the second neural network 20
69 first resulting signal
70 second resulting signal
72 unavailability of the copy of the first intermediate network data 47

1. A method to mitigate an effect of spatial artifacts in an acoustic signal in a binaural hearing system, the method comprising the steps of:
(a) providing a first hearing device and a second hearing device that are configured for a left ear and a right ear of an end user, respectively, and
wherein the hearing devices are configured to form a binaural hearing system, and wherein the first hearing device comprises a first neural network and the second hearing device comprises a second neural network, (b) receiving a first acoustic audio input at the first hearing device and a second acoustic audio input at the second hearing device and converting the first acoustic audio input into a first audio input, and converting the second acoustic audio input into a second audio input, (c) generating first intermediate network data based on the first audio input in the first neural network, and generating second intermediate network data based on the second audio input in the second neural network such that the first intermediate network data comprise at least one first binaural cue, and such that the second intermediate network data comprise at least one second binaural cue, (d) transmitting a copy of the second intermediate network data from the second hearing device to the first hearing device, while maintaining the second intermediate network data in the second hearing device, (e) providing in the first neural network a first processing instruction based on the first intermediate network data and the copy of the second intermediate network data received from the second hearing device, and providing in the second neural network a second processing instruction based on the second intermediate network data, (f) conducting a signal processing by applying the first processing instruction to the first audio input at the first hearing device, and the second processing instruction to the second audio input at the second hearing device.

2. The method according to claim 1, characterized in that step (d) further comprises a transmitting of a copy of the first intermediate network data from the first hearing device to the second hearing device while maintaining the first intermediate network data in the first hearing device, and in that a provision of the second processing instruction in the second neural network in step (e) is based on the second intermediate network data and the copy of the first intermediate network data received from the first hearing device.

3. The method according to claim 2, characterized by a step of synchronizing in the first hearing device the first intermediate network data that is based on the first audio input at a moment in time (t1) with the copy of the second intermediate network data that is based on the second audio input from the moment in time (t1), and providing an input for the step of providing the first processing instruction, and synchronizing in the second hearing device the second intermediate network data that is based on the second audio input at the moment in time (t1) with the copy of the first intermediate network data that is based on the second audio input from the same moment in time (t1), and providing an input for the step of providing the second processing instruction.

4. The method according to claim 1, characterized in that the first binaural cue, and also the second binaural cue comprise at least one member of the following group, each:
a) an interaural level difference (ild),
b) an interaural time difference (itd),
c) a correlation between the first acoustic audio input at the first hearing device and a second acoustic audio input at the second hearing device,
d) a speaker location relative to a head of the end user wearing the first hearing device and the second hearing device,
e) a magnitude of a signal,
f) a phase of a signal,
g) a modulation of a signal.

5. The method according to claim 1, characterized by an additional step of compressing and/or encoding the copy of the second intermediate network data, and also the copy of the first intermediate network data prior to carrying out step (d), and by an additional step of decompressing and/or decoding the copy of the second intermediate network data and the copy of the first intermediate network data, prior to carrying out step (e), where available, each.

6. The method according to claim 1, characterized in that step (b) is performed by two primary microphones located in the first hearing device and the second hearing device, each.

7. The method according to claim 1, characterized in that the transmission the copy of the intermediate network data, where available, from the first hearing device to the second hearing device and vice versa can be switched off selectively.

8. The method according to claim 1, characterized in that the transmitting of the copy of the second intermediate network data to the first hearing device, and also the transmitting of the copy of the first intermediate network data to the second hearing device, is frequency dependent.

9. The method according to claim 1, characterized in that the second intermediate network data and the first intermediate network data, if available, too, comprise information that contributes to reducing acoustic noise of the second audio input and the first audio input, respectively, at step (f).

10. The method according to claim 1, characterized in that in the step of providing the first processing instruction, the copy of the second intermediate network data is considered by the first neural network to a first extent, wherein the first extent is based on a signal quality of the copy of the second intermediate network data, and if available, the copy of the first intermediate network data is considered by the second neural network to a second extent, wherein the second extent is based on a signal quality of the copy of the first intermediate network data.

11. A training method for training a first neural network and a second neuronal network such that they are suitable for a use in the method according to claim 1, characterized in that the algorithms stored in the neural network provided in both the first hearing device and the second hearing device, each, have been trained with a plurality of spatialized datasets.

12. The training method according to claim 11, characterized in that at least one of an interaural level difference (ild) and an interaural time difference (itd) measured between a first audio signal and a second audio signal corresponding to the first audio input and the second audio input, respectively, and a signal output after the application of the first processing instruction to the first audio input at the first hearing device and the second processing instruction to the second audio input at the second hearing device, respectively, forms a cost function that was derived during a training phase of the neural network for the neural networks.

13. The training method according to claim 11, characterized by the provision of another cost function residing in that at least one of the first neural network and the second neural network is configured such that it controls an exchange rate for the transmission of the copy of the first intermediate network data and the second intermediate network data in step (d), respectively.

14. The training method according to claim 11, characterized by the provision of yet another cost function that comprises a balance between at least one of the group comprising a minimal power consumption of the hearing device, a maximal binaural noise suppression, or a minimal amount of binaural artefacts.

15. A binaural hearing system comprising a first hearing device and a second hearing device that are configured such that they are capable to perform the method according to claim 1.
